(19) United States
(12) Patent Application Publication
(10) Pub. No.: US 2004/0233142 A1
(43) Pub. Date: Nov. 25, 2004

(54) Display device

(76) Inventors: Shoichiro Matsumoto, Ogaki-shi (JP); Miwa Ogawa, Hirakata-shi (JP)

Correspondence Address: Michael A. Cantor, Esq., CANTOR COLBURN LLP, 55 Griffin Road South, Bloomfield, CT, 06002, US

(21) Appl. No.: 10/833,183

(22) Filed: Apr. 27, 2004

(30) Foreign Application Priority Data
May 22, 2003 (JP) 2003-145429
Mar. 18, 2004 (JP) 2004-77498

(51) Int. Cl. G09G 3/30; G09G 5/00

(52) U.S. Cl. 345/76

(57) ABSTRACT

An operation point voltage signal and a current video signal are received and stored in a video data processor circuit and a current signal is output onto a data line for a period of one horizontal line. A current-driven pixel circuit can be driven by an operation point voltage signal and a current video signal.

### BACKGROUND OF THE INVENTION

1. Field of the Invention

The present invention relates to a display device in which a current video signal is supplied to each of pixels formed in a matrix form, a current corresponding to the current video signal is supplied to an emissive element, and display is achieved.

2. Description of the Related Art

Because electroluminescence (hereinafter simply referred to as “EL”) display devices in which a self-emitting EL element is used as an emissive element in each pixel have advantages such as that the device is thin, self-emitting, and consumes less power, EL display devices have attracted much attention as alternatives to display devices such as liquid crystal display (LCD) and cathode ray tube (CRT) display devices.

In particular, a high resolution display can be achieved by an active matrix EL display device in which a switching element such as a thin film transistor (hereinafter simply referred to as “TFT”) for individually controlling an EL element is provided in each pixel, and the EL element in each pixel is controlled.

In an active matrix EL display device, a plurality of gate lines extend along a row direction over a substrate, a plurality of data lines and power supply lines extend along a column direction over the substrate, and each pixel has an organic EL element, a selection TFT, a driver TFT, and a storage capacitor. In this structure, a gate line is selected so that the selection TFT is switched on, a data voltage (voltage video signal) on a data line is charged into the storage capacitor, and the driver TFT is switched on by this data voltage to allow electric power to flow from a power supply line through the organic EL element.

Japanese Patent Laid-Open Publication No. 2001-147659 (hereinafter referred to as the “'659 Publication”) discloses a circuit in which two p-channel TFTs are added in each pixel as control transistors and a data current (current video signal) corresponding to display data is supplied onto a data line.

In the circuit disclosed in the '659 Publication, a current video signal is supplied to a data line and through a current-to-voltage converter TFT to set a gate voltage of the driver TFT.

According to the circuit of the '659 Publication, it is possible to set the gate voltage of the driver TFT based on a data current flowing through the data line. With this structure, it is possible to more precisely control a drive current of an EL element compared to a configuration in which a voltage signal is supplied to the data line. In addition, by employing a common current-to-converter TFT, it is possible to reduce the number of components.

The '659 Publication, however, fails to disclose a specific structure for a driver for supplying a data current onto the data line. When a data current is actually supplied to the data line to set the gate voltage of the driver TFT, there is a problem in that a significant time is required for this setting of the gate voltage.

### SUMMARY OF THE INVENTION

The present invention advantageously provides a structure in which both a voltage signal and a current video signal are used to complete writing of data relatively quickly, and a current-driven pixel circuit is used to achieve precise control of a light emission current.

### BRIEF DESCRIPTION OF THE DRAWINGS

FIG. 1 is a diagram showing a structure according to a preferred embodiment of the present invention.

FIG. 2 is a diagram showing an example structure of a pixel circuit.

FIG. 3 is a diagram showing a circuit of FIG. 1 in more detail.

FIG. 4 is a diagram showing various signal waveforms in the circuit of FIGS. 1 and 3.

FIG. 5 is a timing chart for the circuit of FIGS. 1 and 3.

FIG. 6 is a diagram showing a structure of a circuit for generating signals DS1 and DS2.

FIG. 7 is a diagram showing signal waveforms in the circuit of FIG. 6.

FIG. 8 is a diagram showing another example structure of a pixel circuit.

FIG. 9 is a diagram showing a structure in which a pixel circuit of FIG. 8 is used.

FIG. 10 is a diagram showing another example structure of a pixel circuit.

FIG. 11 is a diagram showing various signal waveforms in the circuit of FIG. 10.

FIG. 12 is a diagram showing a structure of another preferred embodiment of the present invention.

FIG. 13 is a is a diagram showing signal waveforms in the preferred embodiment shown in FIG. 12.

FIG. 14 is a diagram showing a circuit for generating a read signal of a video signal for a three-color RGB display.

FIG. 15 is a diagram showing signal waveforms in the circuit of FIG. 14.

FIG. 16 is a schematic diagram showing an overall structure of a display device.

### DESCRIPTION OF PREFERRED EMBODIMENTS

Preferred embodiments of the present invention will now be described referring to the drawings.

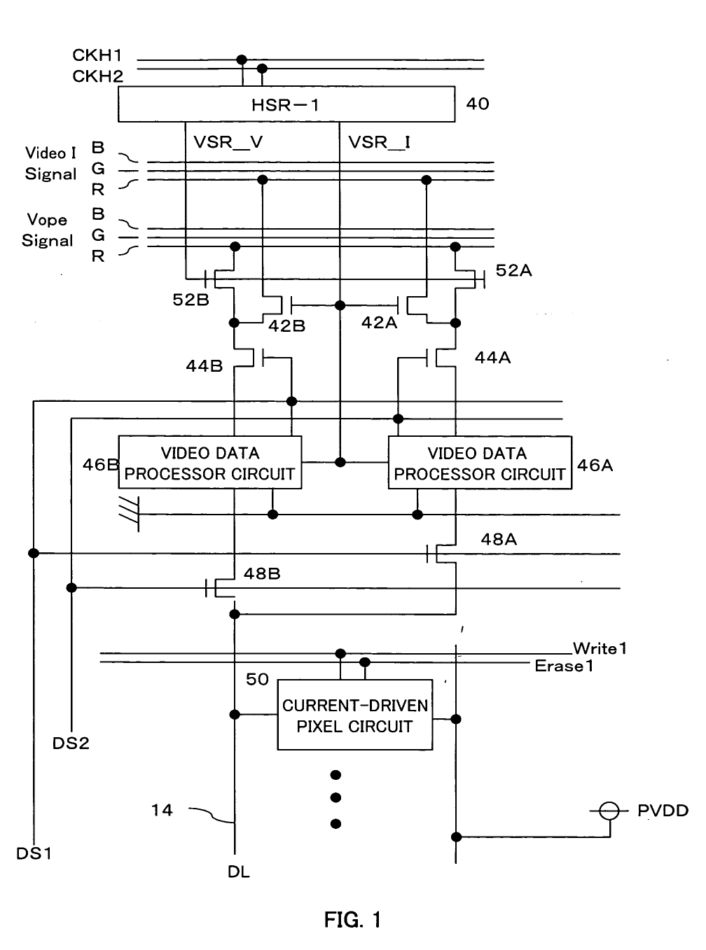

FIG. 1 is a diagram showing a structure of a first preferred embodiment. A pair of clocks CKH1 and CKH2 are input into a horizontal shift register 40. The clocks CKH1 and CKH2 are signals which repeat H and L levels based on a video signal for each pixel and correspond to a pixel clock in a typical video signal. The clock CKH2 is an inverted signal of the clock CKH1.

Gates of a pair of n-channel TFTs 42A and 42B are connected to an output VSR_I of the horizontal shift register 40 and gates of a pair of n-channel TFTs 52A and 52B are connected to an output VSR_V of the horizontal shift register 40. Drains of the TFTs 42A and 42B are connected to a line for supplying a current video signal VideoISignal (in the illustrated structure, R signal line) and drains of the TFTs 52A and 52B are connected to a line for supplying an operation point voltage signal VopeSignal (in the illustrated structure, R signal line). Sources of TFTs 42A and 52A are connected to a drain of an n-channel TFT 44A and sources of TFTs 42B and 52B are connected to a drain of a TFT 44B. The sources of the TFTs 44A and 44B are respectively connected to video data processor circuits 46A and 46B. data selection signals DS2 and DS1 are respectively input to gates of the TFTs 44A and 44B and to the video data processor circuits 46A and 46B.

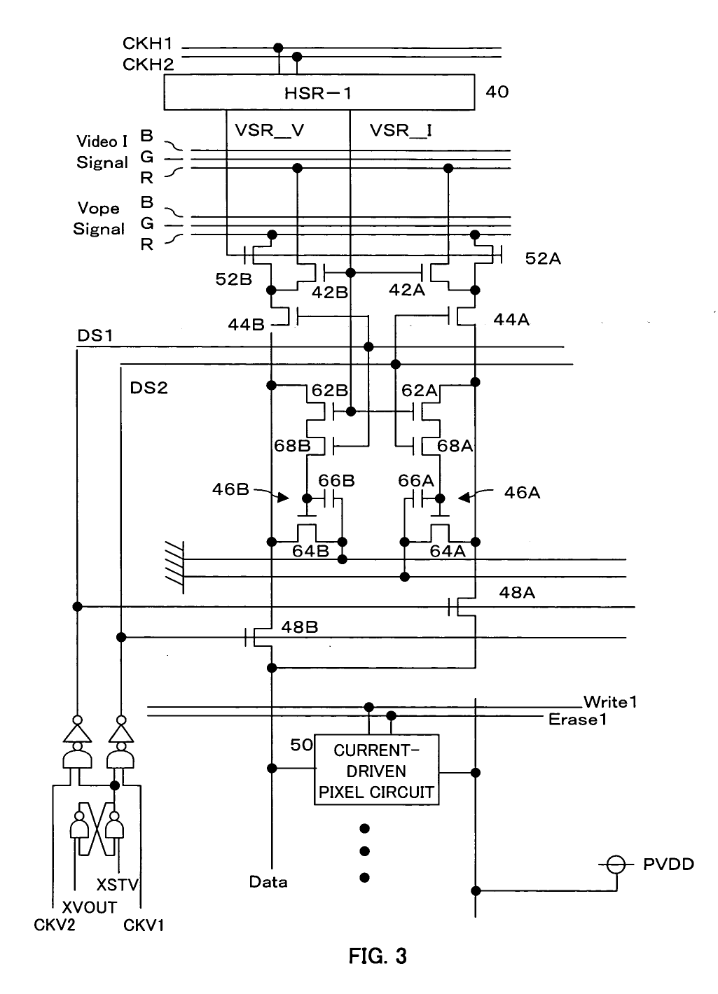

The video data processor circuits 46A and 46B are provided corresponding to each column, and store an input current video signal VideoISignal indicating an emission brightness of a corresponding pixel and output the stored video signal onto a data line DL as a data current. In particular, the video data processor circuits 46A and 46B not only receive the current video signal VideoISignal, but also receive an operation point voltage signal VopeSignal and store a voltage for outputting a data current based on both of these signals. The operation point voltage signal VopeSignal is a voltage signal which is determined based on a gate voltage (operation point voltage) required to supply a current corresponding to the current video signal VideoISignal through a current output TFT, and quickly changes the gate voltage of the output TFT to a voltage close to a target voltage to be set. The operation point voltage is a gate voltage of a TFT 64 (which will be described later with reference to FIG. 3) when a data current corresponding to a current video signal VideoISignal flows through the TFT 64, and is determined based on characteristics of the TFT 64 and the current video signal VideoISignal.

In FIG. 1, one video data processor circuit 46A and one video data processor circuit 46B corresponding to one column within one line are shown, and, thus, the video data processor circuits 46A and 46B store data of one pixel and output the stored data as a data current for a duration of one line. Two video data processor circuits 46A and 46B are provided in each column so that, when video data for one line is sequentially input to and stored in one of the video data processor circuits 46A and 46B in each column, while this video data processor circuit (46A or 46B) outputs a current corresponding to the stored data for the next one line period, the other video data processor circuit (46B or 46A) can store the data for the next line.

Outputs of the video data processor circuits 46A and 46B are respectively connected to drains of n-channel TFTs 48A and 48B and the selection signals DS1 and DS2 are respectively supplied to the gates of the TFTs 48A and 48B. Sources of the TFTs 48B and 48A are connected to the data line DL of the corresponding column. Therefore, when the TFT 44A remains switched on, the TFT 48B is switched on, and the output of the video data processor circuit 46B is supplied onto the data line DL. Similarly, as long as the TFT44B remains switched on, the TFT 48A is switched on, and the output of the video data processor circuit 46A is supplied onto the data line DL.

In this manner, operations of writing of data for one line by a video signal of the previous line and subsequent output of this data for one line during the next one line period are repeated.

A current-driven pixel circuit 50 is connected to the data line DL. The current-driven pixel circuits 50 are sequentially selected and driven by the gate lines. In the present embodiment, because a current-driven pixel circuit 50 is employed, each gate line includes two lines of Write and Erase.

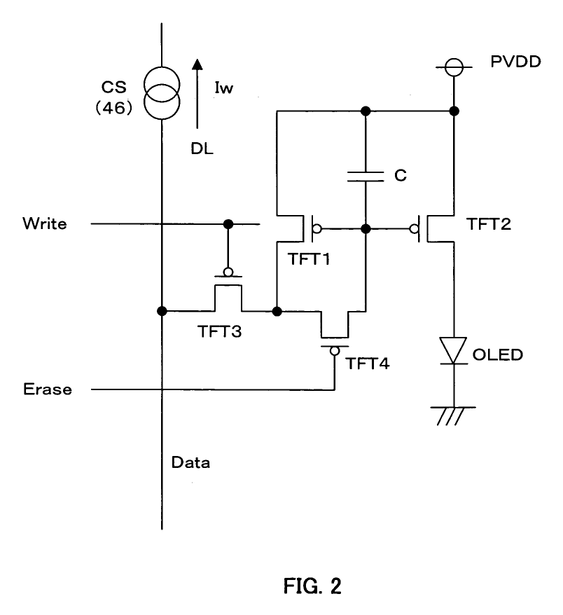

An example structure of the pixel circuit 50 will now be described referring to FIG. 2. As shown in FIG. 2, one terminal of a p-channel TFT (selection TFT) 3 having its gate connected to a gate line Write is connected to the data line DL to which a data current Iw is supplied from a current source CS (which corresponds to the video data processor circuit 46), and the other terminal of the p-channel TFT 3 is connected to one terminal of a p-channel TFT 1 and to one terminal of a p-channel TFT 4. The other terminal of the TFT 1 is connected to a power supply line PVDD and a gate of the TFT 1 is connected to a gate of a p-channel TFT (driver TFT) 2 for driving an organic EL element OLED. The other terminal of the TFT 4 is connected to the gates of the TFTs 1 and 2. The gates of the TFTs 1 and 2 are further connected to the power supply line PVDD via a storage capacitor C. A gate of the TFT 4 is connected to the gate line Erase.

With this structure, Write becomes an L level and Erase becomes an L level so that the TFTs 3 and 4 are switched on. A data current Iw is supplied onto the data line DL. With this operation, the gate and source of the TFT 1 are short-circuited (connected) and the current Iw flows through the TFTs 1 and 3. The current Iw is converted to a voltage and this voltage is set on the gates of the TFTs 1 and 2. After the TFTs 3 and 4 are switched off, the gate voltage of the TFT 2 is stored by the storage capacitor C, and, thus, a current corresponding to the current Iw continues to flow through the TFT 2 and the organic EL (OLED) emits light by this current. When Erase is switched to an L level, the TFT 4 is switched on, which causes the gate voltage of the TFT 1 to be increased, the storage capacitor C to be discharged, the data to be erased, and the TFTs 1 and 2 to be switched off.

In this circuit, when a current flows through the TFT 1, a corresponding current flows through the TFT 2 which forms a current mirror structure with the TFT 1. In this state, the gate voltage of the TFTs 1 and 2 is determined, the determined voltage is stored in the storage capacitor C, and an amount of current flowing through the TFT 2 is determined based on this voltage.

FIG. 3 shows an internal structure of the video data processor circuits 46A and 46B. The video data processor circuits 46A and 46B basically have the same structure and will be described omitting the indication of A and B.

The video data processor circuit 46 has three n-channel TFTs 62, 64, and 68 and a storage capacitor 66. A signal VSR_I is supplied to a gate of the TFT 62 similar to the TFT 42. A drain of the TFT 62 is connected to the source of the TFT 44 and a source of the TFT 62 is connected to a drain of the TFT 68. Similar to the TFT 44, the gate of the TFT 68 is connected to one of the data selection signals DS1 and DS2 (the gate of the TFT 68A is connected to DS2 and the gate of the TFT 68B is connected to DS1). A source of the TFT 68 is connected to a gate of the TFT 64. A drain of the TFT 64 is connected to the source of the TFT 44 similar to the drain of the TFT 62 and a source of the TFT 64 is connected to ground. The capacitor 66 is connected between the gate and the source of the TFT 64.

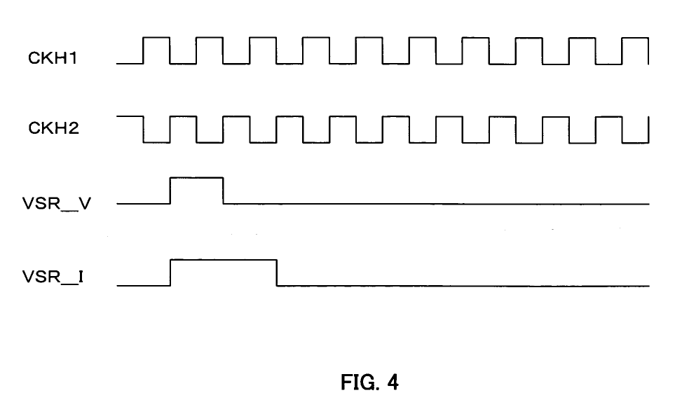

FIG. 4 shows waveforms of signals VSR_V and VSR_I. As shown, the signals VSR_V and VSR_I simultaneously become an H level and the VSR_V continues to be at the H level for twice the duration of the H level of CKH1 or CKH2 and the VSR_I continues to be at the H level for four times the duration of the H level of the CKH1 or CKH2. Because both VSR_V and VSR_I become the H level, the TFTs 42, 62, and 52 are switched on. In addition, either the TFTs 44A and 48B are switched on or the TFTs 44B and 48A are switched on.

With this operation, both signals VideoISignal and VopeSignal are supplied to the drains of the TFTs 62 and 64. As described before, the TFT 68 is placed between the source of the TFT 62 and the gate of the TFT 64 and is also in the ON state.

Therefore, charging of the capacitor 66 is performed by both signals of VideoISignal and VopeSignal, and a current corresponding to the charged voltage in the capacitor 66 flows through the TFT 64 to ground.

Then, VSR_V becomes an L level and the TFT 52 is switched off while the VSR_I continues to be in the H level. Thus, the TFT 62 is switched on and the VideoISignal supplied through the TFT 42 while the gate and drain of the TFT 64 are short-circuited (connected) flows through the TFT 64 to ground, and a gate voltage at this condition is stored in the capacitor 66. When the VSR_I becomes the L level, the TFTs 42 and 62 are switched off and the gate voltage of the TFT 64 is determined.

At the timing of writing of data to the next line, one of the TFTs 48A and 48B which corresponds to the TFT 64A or 64B to which a signal is written as described above is switched on, a data current Iw which is identical to the VideoISignal is supplied through the TFT 64A or 64B to the data line DL, and the current-driven pixel circuit 50 is driven by the data current Iw.

Because the TFT 68A or 68B connected to the gate of the TFT 64 which is outputting the data current Iw is switched off, the writing of signal by the current video signal VideoISignal and the operation point voltage signal VopeSignal is not performed.

As described, in the present embodiment, when data is to be written to the video data processor circuit 46, the capacitor 66 (66A or 66B) is first charged with two signals, VSR_V and VSR_I. Therefore, it is possible to relatively quickly charge the capacitor 66. Then, a current video signal VideoISignal is supplied through the TFT 64 to charge the capacitor 66. Therefore, it is possible to maintain, in the capacitor 66, the gate voltage when the current video signal VideoISignal is supplied. With this structure, it is possible to very precisely set a data current to be actually supplied to the current-driven pixel circuit 50.

Referring again to FIG. 3, while the capacitor 66 is charged by the video data, the current flowing through the TFT 64 (64A or 64B) flows to ground. Therefore, there is a possibility that the potential of ground GND is locally increased by the current flowing through the TFT 64 (64A or 64B). The video data is written into the capacitor 66 (66A or 66B) in a point-sequential manner, but if the potential of ground GND changes during the writing operation, this increase in the GND becomes a noise, which makes it impossible to precisely read the video data.

In the present embodiment, the sources of the TFTs 64A and 64B in the video data processor circuits 46A and 46B are respectively connected to ground GND through separate lines. With this configuration, because the current flows separately into ground GND through separate lines, it is possible to inhibit local increase in the potential of ground GND. In other words, in a typical structure, the sources of the TFTs 64A and 64B are connected to the same ground and one line is provided common to the TFTs. However, by separating the lines as in the present embodiment, it is possible to stably write video data. For example, while the TFT 44B is switched on and data is being written into the capacitor 66B, the TFT 64B is switched on and the current flows through the TFT 64B to ground GND. At the same time, the TFT 48A is at the ON state and a current from the data line DL flows through the TFT 64A to ground GND. In the present embodiment, because the TFTs 64A and 64B are connected to ground GND through separate lines, it is possible to stably supply the current to ground GND.

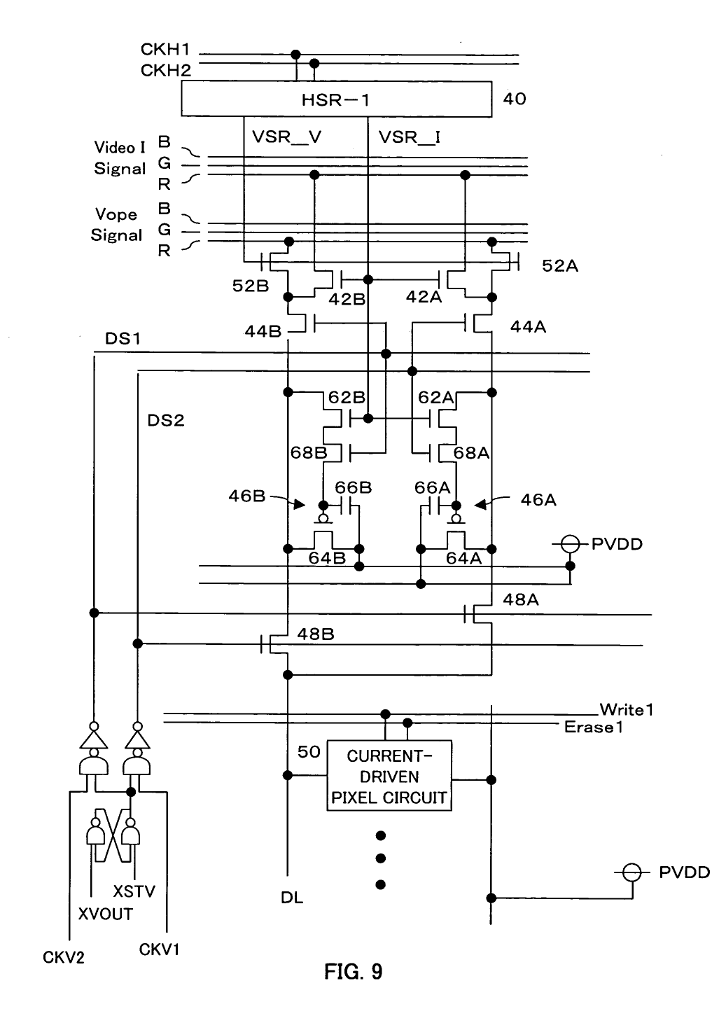

In FIG. 3, because n-channel TFTs are employed for the TFTs 64A and 64B, the sources are connected to ground GND, but when p-channel TFTs are employed for the TFTs 64A and 64B as in the configuration shown in FIG. 9 which will be described later, the sources are connected to the power supply line PVDD.

It is desirable that a p-channel TFT be connected in parallel with the n-channel TFT 44A in which a data selection signal DS2 is to be supplied onto the gate and to supply the signal DS1 to a gate of the TFT which is connected in parallel. In this configuration, the TFT which is connected in parallel to the TFT 44A is switched on and off at the same timing. Similarly, it is desirable that a p-channel TFT be connected in parallel with the n-channel TFT 44b in which the signal DS1 is to be supplied onto the gate and to switch the TFTs on and off at the same timing. In this manner, by connecting transistors in parallel, it is possible to remove noise to the write signal and to improve the capability of the switch, to thereby increase a selection range of the write voltage.

In addition, it is desirable that a plurality of TFTs 62 be provided in parallel to achieve redundancy in the circuit. It is also possible to connect the source electrodes of the parallel TFTs 62 to ground voltage or to an arbitrary power supply of, for example, a negative potential, and to employ different layouts of lines so as to inhibit changes in the power supplies.

It is also preferable that the data selection signals DS1 and DS2 are separately generated in plurality so that the TFT 44 and the TFT 48 are separately driven. By separating in this manner, each operation can be reliably performed.

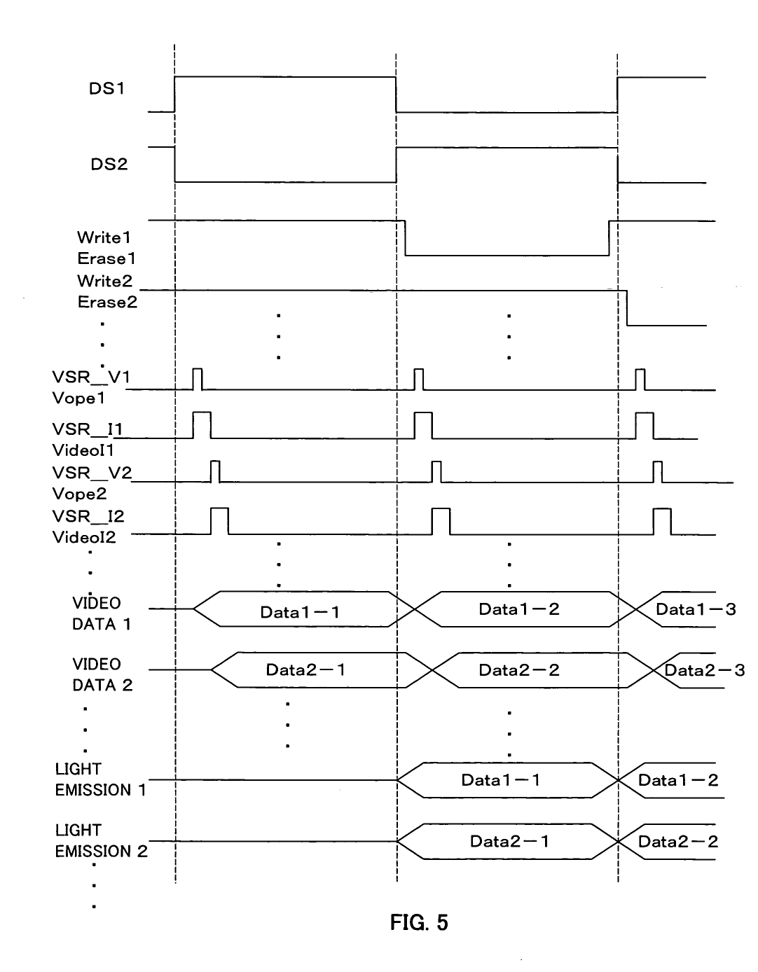

FIG. 5 is a timing chart of operations in the circuit of FIGS. 1 and 3. Signals DS1 and DS2 are complementary signals which repeat H and L levels every horizontal period (1H) and have polarities inverted from each other. The signals VSR_V (VSR_V1, VSR_V2, . . . ) and VSR_I (VSR_I1, VSR_I2, . . . ) output from the horizontal shift register 40 control timings for the corresponding video data processor circuit 46 to read the current video signal VideoISignal (VideoI1, VideoI2, . . . ) and the operation point voltage signal VopeSignal (Vope1, Vope2, . . . ).

Based on the switching of the video signal, signals (Vope1, VideoI1), (Vope2, VideoI2), . . . are output, and, in the stage in which signals for pixels in a column corresponding to the video signal are supplied, signals (VSR_V1, VSR_I1), (VSR_V2, VSR_I2), . . . corresponding to each column become an H level in order and the video signals are sequentially read by the video data processor circuits 46A and 46B of the corresponding column.

As video signals of the next horizontal line after reading of the video signal by the video data processor circuit 46A are supplied, the signals Write1 and Erase1 are both at the L level and outputs (data current) from all video data processor circuits 46A are supplied to the data lines DL for a 1H period. Based on Data 1(column)-1(row), Data 1-2, . . . , light is emitted from the corresponding pixel circuit. In this process, video signals for one line (current video signal VideoISignal) are sequentially stored in the video data processor circuit 46B. The figure does not show the period in which only Erase is at the L level and the storage capacitor C is discharged. This period in which only Erase is at the L level is provided at a timing before that of the writing of data.

During the next horizontal period, Write2 and Erase2 become an L level and outputs (data current) from all video data processor circuits 46A are supplied onto the data lines DL for the 1H period. Based on the Data1-1, 2-1, . . . , the organic EL element OLED in the corresponding pixel circuit 50 emits light.

In the present embodiment, the conductive type of all of the TFTs, including the driver TFT 2, in the current-driven pixel circuit 50 is p-channel. In a structure in which the TFT 2 is of the p-channel type, when the video data is to be written, the setting current Iw is drawn to the video data processor circuit 46 from a high voltage PVDD within a pixel through the data line. In the present embodiment, an n-channel TFT is employed as the TFT 64 within the video data processor circuit 46, with the source connected to ground. With this structure, it is possible to set the source at a low potential and to precisely control the setting current Iw.

As described, by employing TFTs of opposite conductive types in the driver TFT 2, which is the driver element within the current-driven pixel circuit 50, and the TFT 64, which is an output transistor of the video data processor circuit, it is possible to precisely control the setting current Iw.

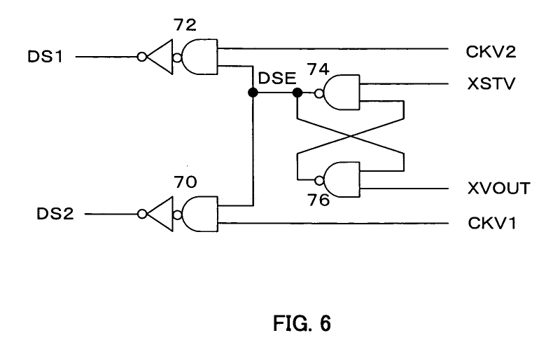

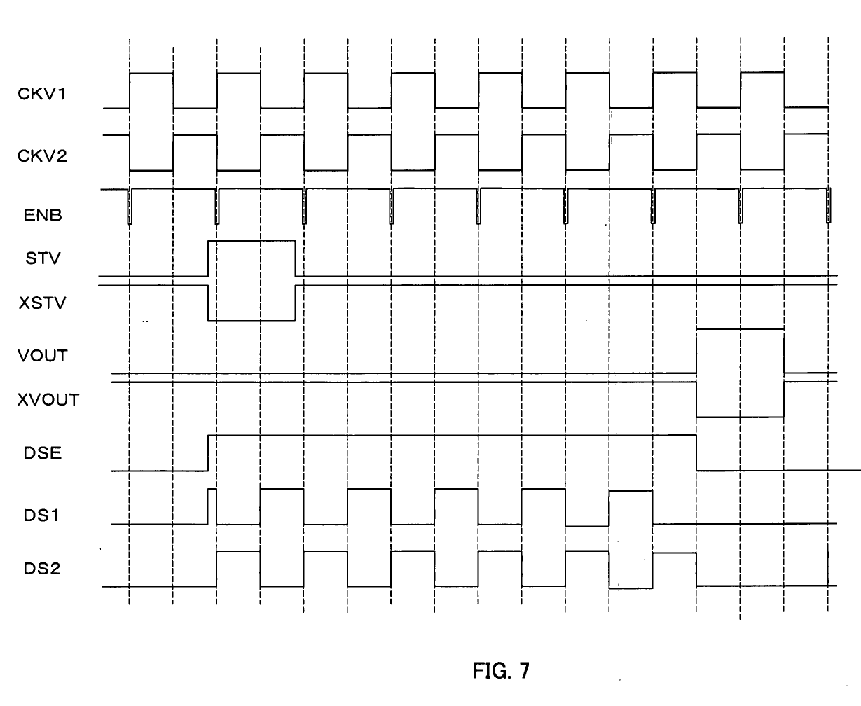

FIG. 6 shows a structure of a circuit for generating the signals DS1 and DS2. FIG. 7 shows waveforms of various signals in the circuit of FIG. 6.

Signals CKV1 and CKV2, which are complementary and repeat H and L levels every one horizontal period, are respectively input to AND gates 70 and 72 from which the signals DS2 and DS1 are respectively output. A signal XSTV which is an inverted signal of a start signal STV which indicates the start of display of a vertical period is input to a NAND gate 74 and a signal XVOUT which is an inverted signal of a signal VOUT which indicates the completion of display in the vertical period is input to a NAND gate 76. An output of the NAND gate 74 is input to the NAND gate 76 and an output of the NAND gate 76 is input to the NAND gate 74. An output from the NAND gates 74 and 76 is input to the AND gates 70 and 72 as a signal DSE. The NAND gates 74 and 76 form a flip-flop structure which is set to an H level when the XSTV becomes an L level and which is reset to L when the XVOUT becomes an L level. The signal DSE becomes an L level during a vertical blanking period from the H of the VOUT to the H of the STV. Because the DSE is input to the AND gates 70 and 72, DS2 and DS1 are signals which maintain the L level during the vertical blanking period and which repeat H and L similar to the signals CKV1 and CKV2 only during the display period.

An enable signal ENB, which becomes an L level when the gate line is switched, prohibits output regarding the gate lines Write and Erase and ensures that the pixel circuit does not operate during the switching.

In this manner, by employing the signal DSE as described, it is possible to fix the signals DS1 and DS2 at the L level during the vertical blanking period, prohibit operations of the corresponding element (an element or elements which are switched on and off by the signals DS1 and DS2) during this period, and to reduce power consumption.

The signals DS1 and DS2 are independently output and are supplied to the TFT 44 and TFT 48 through separate lines to control the TFTs. Therefore, compared to a configuration in which both TFT 44 and TFT 48 are controlled by a signal output onto one signal line, it is possible to employ transistors of lower capability to form the AND gates 70 and 72, to thereby reduce the delay time, layout area, and power consumption. For example, when only one AND gate 70 or 72 is provided, the gate width (W) of the transistor forming the AND gates must be 300 μm or greater. On the other hand, in a structure as in the present embodiment, in which two signals of DS1 and DS2 are independently output, the gate width W of the transistors forming the AND gates can be about 30 μm. Therefore, it is possible to reduce an area of the transistor, the layout area, and the power consumption. In addition, the drive capability of the transistor can be easily increased to reduce the delay time.

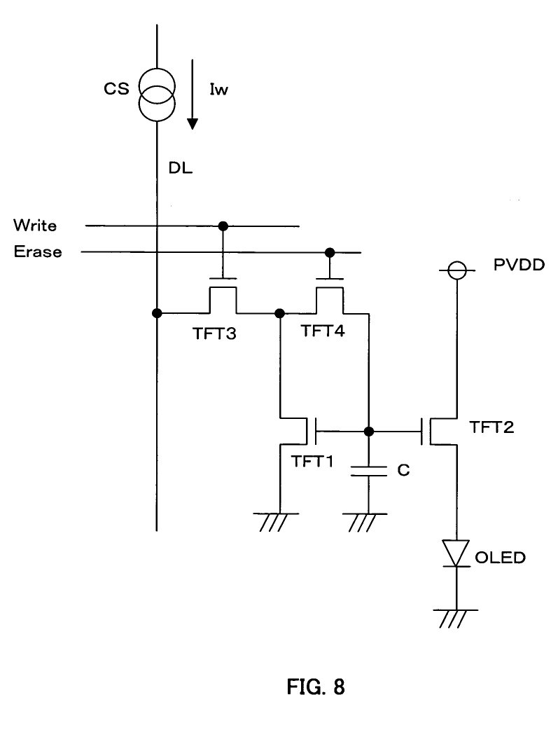

FIGS. 8 and 9 exemplify a structure of another embodiment according to the present invention. FIGS. 8 and 9 correspond to FIGS. 2 and 3, respectively.

FIG. 8 shows a structure of a current-driven pixel circuit 50 in this embodiment. As shown in FIG. 8, n-channel TFTs are employed in the TFTs 1, 2, 3, and 4.

One terminal of the TFT 3 is connected to a data line DL onto which a data current is supplied from a current source CS and the other terminal of the TFT 3 is connected to one terminal of the TFT 1 and one terminal of the TFT 4 (driver TFT). The other terminal of the TFT 1 is connected to ground and a gate of the TFT 1 is connected to a gate of the TFT 2 for driving an organic EL element OLED. The other terminal of the TFT 4 is connected to the gates of the TFTs 1 and 2 and the gates of the TFTs 1 and 2 are connected to ground through a storage capacitor C. A gate of the TFT 4 is connected to a gate line Erase.

When data is to be written, signals of H level are supplied to gate lines Write and Erase. With this operation, the TFTs 3 and 4 are switched on and the data current Iw from the current source CS flows through the TFTs 3 and 1 to ground. Because TFT 4 is in an ON state, the TFT 1 and the TFT 2 form a current mirror structure, and a current corresponding to the current Iw flows through the TFT 2. A gate voltage of the TFT 1 at this condition is stored in the storage capacitor C. A drive current flows through the TFT 2 and the organic EL (OLED) until the line Erase is set to an L level.

When n-channel TFTs are used as in this configuration, the direction of current regarding the video data processor circuit 46 corresponding to the current source CS must be reversed. Therefore, as shown in FIG. 9, p-channel TFTs are employed as the TFTs 64A and 64B with sources of the TFTs 64A and 64B connected to the power supply PVDD. With this structure, the video signal is stored in the capacitor 66A or 66B, a current corresponding to this voltage flows through the TFT 64A or 64B, and the current is supplied to the data line DL.

In the present embodiment, all of the TFTs in the current-driven pixel circuit 50, including the driver TFT 2, are of an n-channel type. With an n-channel TFT 2, when video data (data current) is to be written, the setting current Iw is supplied from the video data processor circuit 46 through the data line to the current-driven pixel circuit 50. In consideration of this, a p-channel TFT is employed as the TFT 64 in the video data processor circuit 46 with the source of the TFT 64 connected to the power supply PVDD. With this structure, it is possible to set the source at a high potential and to precisely control the data current Iw.

In this manner, by employing transistors of opposite conductive types in the driver TFT 2, which is the driver element in the current-driven pixel circuit 50, and the TFT 64, which is an output transistor in the video data processor circuit, it is possible to precisely control the setting current Iw.

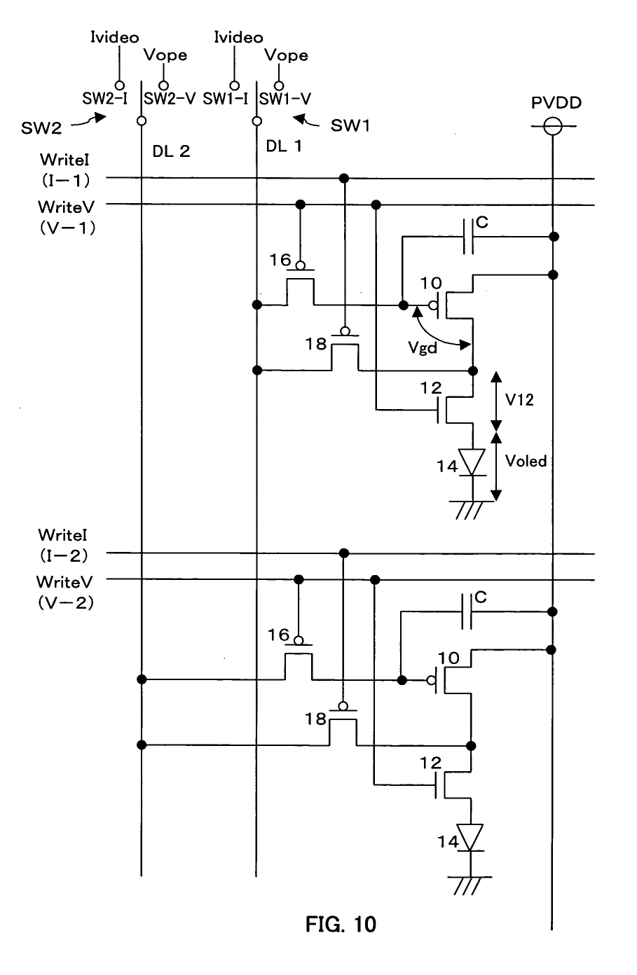

Alternatively, as a current-driven pixel circuit, it is also desirable to use a direct specification type circuit as shown in FIG. 10.

A source of a p-channel TFT 10 is connected to a power supply PVDD and a drain of the p-channel TFT 10 is connected to an anode of an organic EL element 14 through an n-channel TFT 12. A cathode of the organic EL element 14 is connected to ground.

A gate of the TFT 10 is connected to a data line DL (DL1 or DL2) through a p-channel TFT 16 and is also connected to the power supply line PVDD through a storage capacitor C. A connection point between the TFTs 10 and 12 is connected to the data line DL through a p-channel TFT 18.

A write line WriteI which extends along the row direction is connected to a gate of the TFT 18 and a write line WriteV which also extends along the row direction is connected to gates of the TFTs 12 and 16.

In the present embodiment, as the data line DL, a first data line DL1 and a second data line DL2 are provided corresponding to each column. TFTs 16 and 18 are connected to the first data line DL1 and the second data line DL2 alternatively for each row.

Each of the first and second data lines DL1 and DL2 is configured to be selectively switched and supplied with a current video signal Ivideo or a voltage signal VopeData through respective switches SW1 and SW2. The current video signal Ivideo is the signal supplied onto the data line in the above-described embodiments. The switch SW1 selects the signal Ivideo when a signal SW1-I is at an H level and selects the signal VopeData when a signal SW1-V is at an H level. Similarly, the switch SW2 selects the signal Ivideo when a signal SW2-I is at an H level and selects the signal VopeData when a signal SW2-V is at an H level.

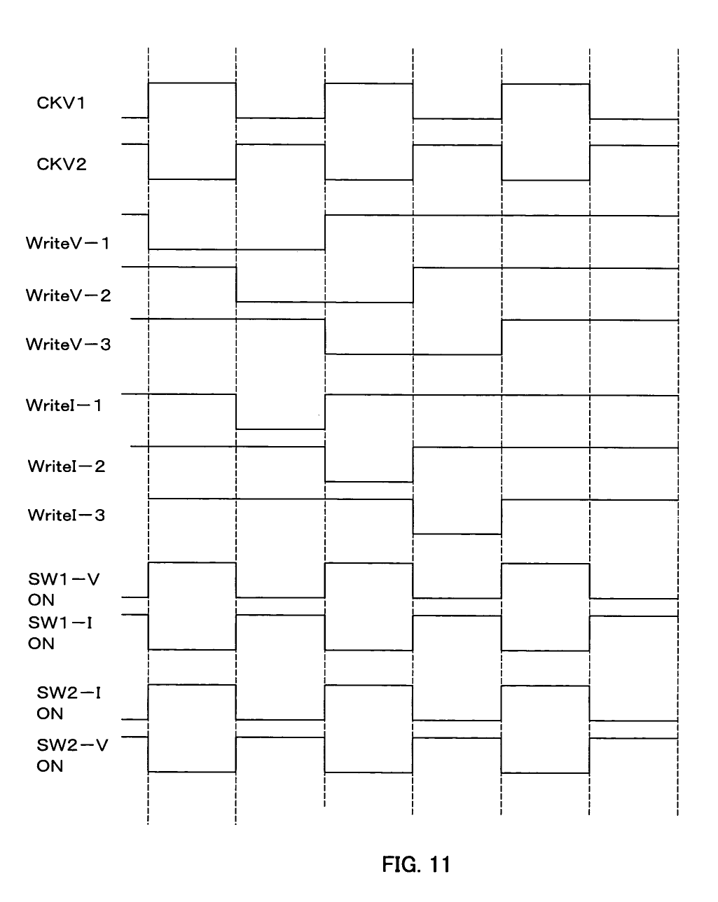

Various control clocks in this circuit will now be described referring to FIG. 11. Two clocks CKV1 and CKV2 complementarily repeat H and L every 1H period (one horizontal period) for controlling signals to pixel circuits of every other row (horizontal line). That is, when the clock CKV1 is at an H level, the clock CKV2 is at an L level, and vice versa.

Write signals WriteV-1, WriteV-2, WriteV-3, . . . for each row become an L level for a duration of 2H period, but the timing for which the write signal becomes L is shifted by 1H in every sequential row. For example, the WriteV-1 becomes an L level for a duration of 2 clock cycles from the timing in which the CKV1 becomes an H level, and then, with a delay of 1H each, the signals WriteV-2 and WriteV-3 sequentially become the L level.

Write signals WriteI-1, WriteI-2, WriteI-3, . . . respectively becomes an L level for 1H period in the second half of the L period of the write signals WriteV-1, WriteV-2, WriteV-3, . . .

A control signal SW1-V of the switch SW1 becomes an H level for 1H period in the first half of the L period of the write signals WriteV-1, WriteV-3, WriteV-5, . . . , and the data line DL1 is connected to VopeData. Similarly, a control signal SW2-V of the switch SW2 becomes an H level in the first half of the L period of the write signals WriteV-2, WriteV-4, WriteV-6, . . . , and the data line DL2 is connected to VopeData.

A control signal SW1-I of the switch SW1 becomes an H level at any time when any of the write signals WriteI-1, WriteI-3, WriteI-5, . . . is at an L level and the data line DL1 is connected to Ivideo. Similarly, a control signal SW2-I of the switch SW2 becomes an H level when any of the write signals WriteI-2, WriteI-4, WriteI-6, . . . is at an L level and the data line DL2 is connected to Ivideo.

Operations by these clocks will now be described referring to an example pixel, a pixel shown in a upper position in FIG. 10.

When the SW1-V becomes an H level, the switch SW1 selects VopeData. Because WriteV-1 is L and WriteI-1 is H, TFTs 12 and 18 are switched off and TFT 16 is switched on, VopeData is charged into a storage capacitor C, and VopeData is set as the gate potential of TFT 10.

The signal VopeData has a voltage value based on brightness data (in a structure of separate R, G, and B, separate brightness data for R, G, and B) for the pixel and charging of the storage capacitor C is quickly completed by the supply of this voltage.

Next, the Sw1-V becomes L and SW1-I becomes H. The switch SW1 now selects Ivideo. While WriteV-1 maintains L level, WriteI-1 becomes the L level, and thus, the TFT 18 is switched on. The current Ivideo flows from the power supply PVDD through the TFTs 10 and 18. The gate voltage of the TFT 10 in a condition in which the current Ivideo flows through the TFT 10 is written into the storage capacitor C. As described above, the gate voltage of the TFT 10 is preliminarily set with VopeData, and the amount of charge/discharge by Ivideo is therefore small. Thus, it is possible to quickly complete the charge/discharge operation, even with a small minimum brightness current, in a display with a large number of gradations.

In this manner, writing of brightness data is completed and the WriteV-1 and WriteI-1 become H. With this operation, the TFT 12 is switched on and a current flows from the power supply PVDD through an organic EL element 14. Because the gate voltage of the TFT 10 is set at the gate voltage of the TFT 10 when Ivideo flows through the TFT 10 and this voltage is stored in the storage capacitor C, the current flowing through the organic EL element 14 is substantially identical to Ivideo.

As described, in the present embodiment, a direct specification system is employed in which Ivideo is supplied through the TFT 10 to set the gate potential, and thus, the current can be precisely controlled. Because the gate voltage can be set in advance with VopeData, it is possible to significantly reduce the time required for writing the brightness data and to easily adapt the display device to a larger number of gradations.

The voltage VopeData to be input will now be described. The voltage VopeData is not a voltage which directly indicates video information, but, rather, is voltage information for providing an operational point of the TFT 10 through which a current signal Ioled which is brightness information is supplied to the organic EL element 14. That is, a current IvideoData to be supplied onto the data line DL corresponding to brightness information is approximately equal to the current Ioled which flows through the organic EL element 14 (Ivideo≈Ioled). When the TFTs 10 and 18 are switched on and Ivideo is supplied, VopeData has a value in which the ON resistances of the TFTs 10 and 18 are subtracted from VDD, that is, VopeData=VDD−(Vgd+V_{TFT18}). When the current Ioled is supplied through the organic EL element 14, on the other hand, VopeData has a value which is equal to a sum of the ON resistance V₁₂ of the TFT 12, the ON resistance Voled of the organic emissive element, and a gate-drain voltage Vgd of the TFT 10, that is, VopeData=Voled+V12+Vgd.

VopeData can be determined in this manner. Because characteristics of the element is known in advance, it is possible to determine VopeData based on a brightness signal. Thus, when a pixel is to be designed, it is possible to calculate a relationship curve related to the conversion of input brightness signal into VopeData in advance through simulations, provide a circuit which performs the conversion based on the relationship curve, and to supply an output of the circuit as VopeData.

VopeSignal in FIGS. 1, 3, 9, and 12 is provided for setting the gate voltage of the output TFT 64 within the video data processor circuit 46 to its operation point voltage, and is determined in a manner similar to the above based on the characteristics of the TFT 64.

In the present embodiment, a data line DL2 is provided parallel to the data line DL1. The pixels in the vertical direction are alternatively connected to the data lines DL1 and DL2, and writing of VopeData and writing of Ivideo are performed for each pixel with a timing which is shifted by 1H of the clock CKV1 from the adjacent row. Therefore, the start timings of light emission of the organic EL element 14 in the pixels in the vertical direction are sequentially shifted by 1H. After DL1 is used to write data to a pixel on the first line in a 2H period, the DL1 is used to write data to a pixel on the third line in the next 2H period, and this operation is repeated for pixels in odd-numbered rows. Similarly, after DL2 is used to write data to a pixel on the second line, DL2 is used to write data to a pixel on the fourth line, and this operation is repeated for pixels in even-numbered rows. The writing of data into a pixel of the second line is 1H later than the writing of data into the pixel on the first line. Thus, from the pixel on the first line, data is written into the pixel sequentially toward the lower pixels in an interval of 1H. Although a total of two clocks, 1H for writing VopeData and 1H for writing Ivideo, are required for writing data to one pixel, the time required for writing data to one column is the same as when data is written to one line in a period of 1H.

In the above description, only pixels of one column are described. In reality, however, writing of voltage (VopeData) for all pixels in one row is sequentially performed during one 1H period and the writing of current (Ivideo) for all pixels in the row is sequentially performed during the next 1H period. When current is written to one line, voltage is simultaneously written on the next row.

In particular, a point-sequential method is employed for writing data of voltage in which VopeData for all pixels on one line is set on DL1 or DL2 in order during 1H period. On the other hand, as described above, a line-sequential method is employed for writing current in which Ivideo of all pixels of one line is simultaneously applied to DL1 or DL2 during the 1H period.

A block-sequential method may be employed for writing current in which pixels of one line are divided into a plurality of blocks and data of Ivideo for each block is applied to DL1 or DL2 within the block in parallel. In such a case, the number of blocks N is determined by dividing the 1H period by the time for writing current. For example, when the time for writing current is tw, N=1H/tw. In this manner, it is possible to reliably write the current.

In addition, although in the above description, switches SW1 and SW2 select either Ivideo or VopeData, it is also possible to supply Ivideo onto the data line also when VopeData is selected.

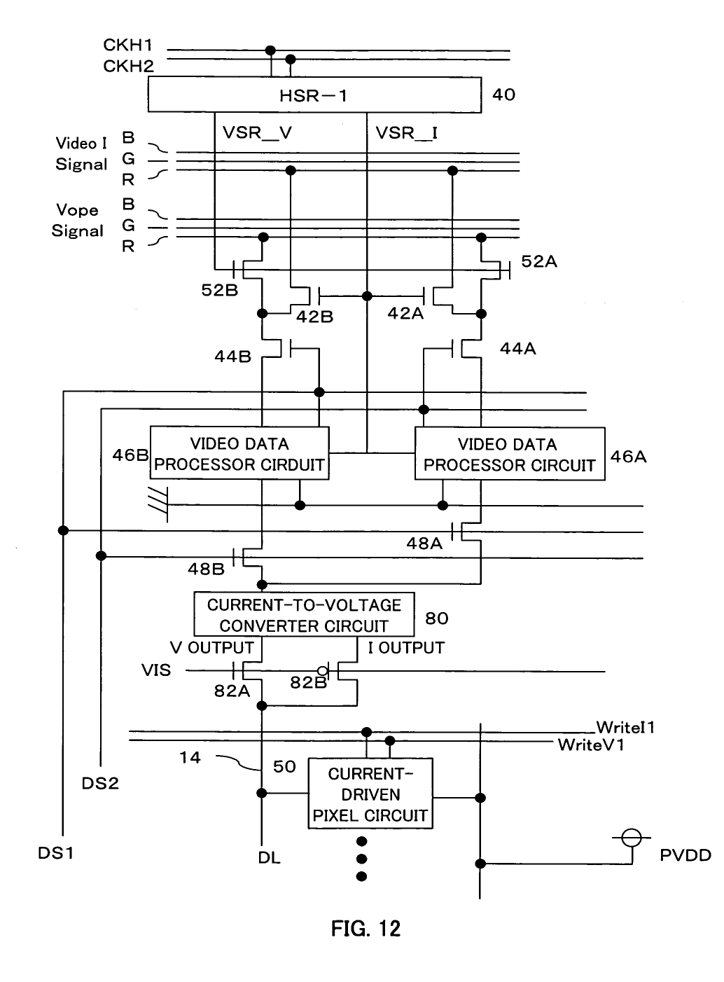

FIG. 12 shows a circuit structure when a current driven pixel circuit 50 is to be driven by both a voltage signal and a current video signal.

As shown in FIG. 12, one of outputs of video data processor circuits 46A and 46B is selected by TFTs 48A and 48B and is input to a current-to-voltage converter circuit 80. In the current-to-voltage converter circuit 80, a V output (VopeData) having a voltage near an operation point of a driver TFT is generated by charging the current video signal to a capacitor or the like. The current-to-voltage converter circuit 80 outputs both an I output which is a current signal corresponding to the current video signal and the V output which is a voltage signal.

The V output is supplied to a data line DL through an n-channel TFT 82A and the I output is supplied to the data line DL through a p-channel TFT 82B. In other words, the TFTs 82A and 82B correspond to switches SW1 and SW2 in FIG. 10.

Therefore, in this circuit, a voltage signal VopeData is generated in the current-to-voltage converter circuit 80 from the current video signal generated in the video data processor circuit 46 and is sequentially supplied to the current driven pixel circuit 50 of direct specification type as shown in FIG. 9.

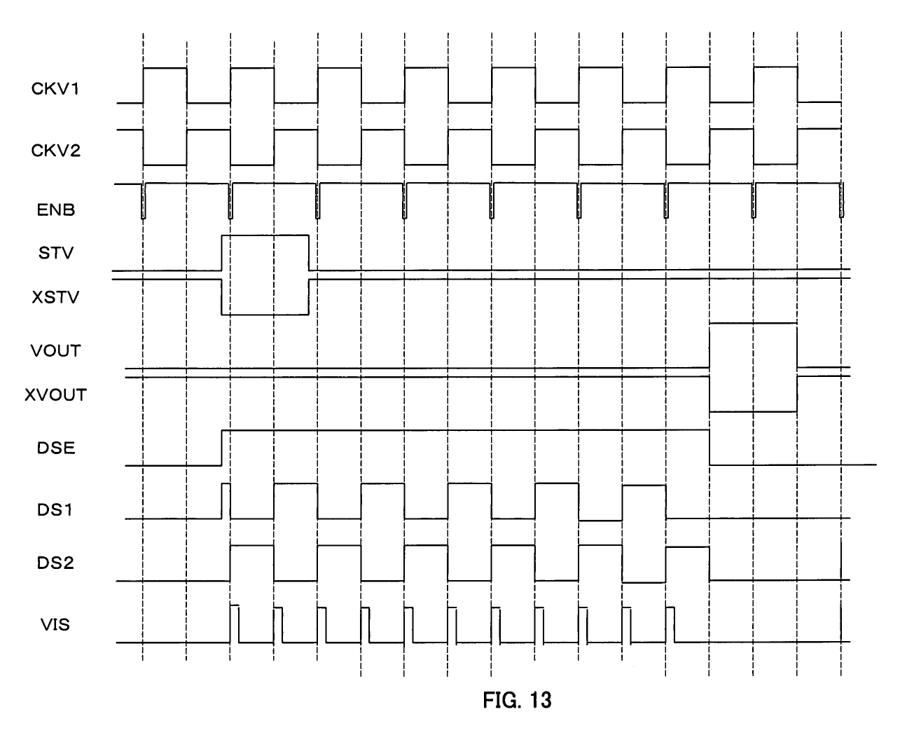

A switching signal VIS is supplied to gates of the TFTs 82A and 82B. Therefore, one data line DL is provided for each column, and the switching signal VIS must be switched within one horizontal line period. FIG. 13 shows a waveform of this switching signal VIS. By employing a signal which is H at an earlier period of one horizontal period and then is switched to L, it is possible to supply VopeData to the data line DL at earlier period of one horizontal period and supply Ivideo thereafter.

When two data lines are provided for each column, as in the structure shown in FIG. 10, it is possible to provide two current-to-voltage converter circuit TFTs 82A and 82B for each column and to sequentially output signals.

In the circuit of FIG. 12, the current signal is output after the voltage signal is output so that these signals are not simultaneously supplied to the data line. However, it is also possible to configure the circuit so that both the voltage signal and the current signal are output at earlier period and then, only the current signal is output.

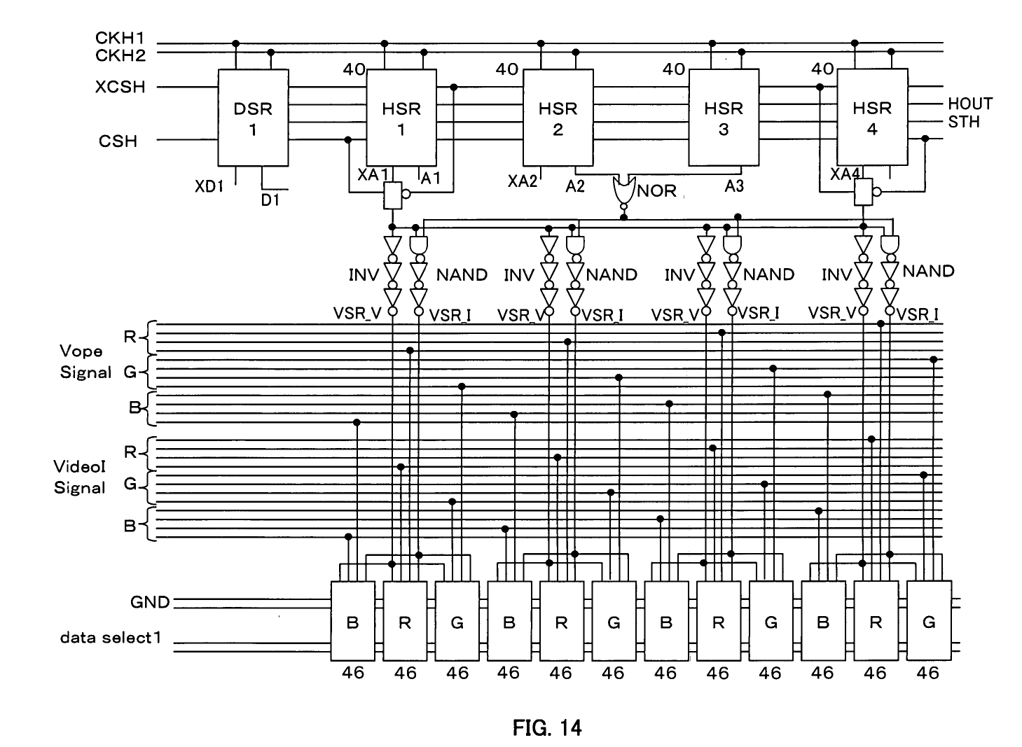

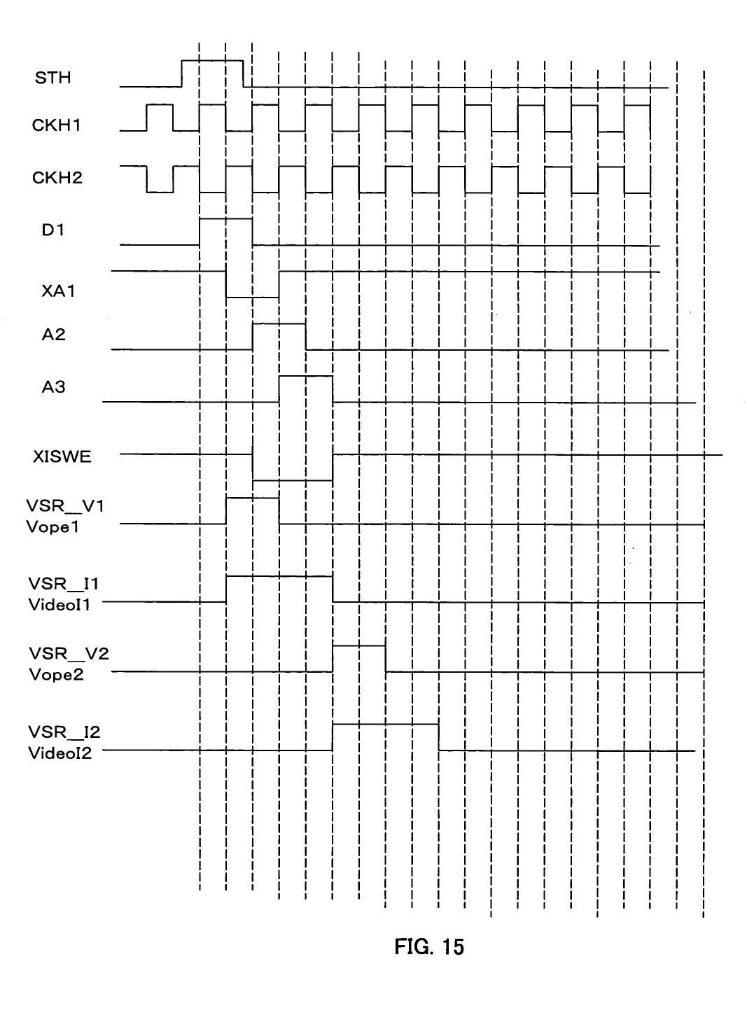

FIG. 14 shows an example structure of a circuit for driving a set of four columns for each color in a circuit in which pixels of three colors of R, G, and B are arranged along the column direction (the total number is 12 columns). In other words, 12 lines determined from R, G, and B (three colors) * 4 are provided for the VopeSignal and VideoISignal in parallel, and the same signal is supplied in parallel to these 12 lines for a period corresponding to four pixels. A timing chart related to this circuit is shown in FIG. 15.

As horizontal shift registers 40, four horizontal shift registers HSR1-HSR4 are shown and the HSR1-HSR4 receive typical transfer clocks CKH1 and CKH2 for the horizontal direction and sequentially transfers H based on the transfer clocks. DSR1 denotes a circuit for generating a signal for achieving a mirror display and the transfer direction of H in the horizontal shift register 40 is inverted based on the output of this circuit. In the configuration shown in FIG. 14, an output XA1 of the HSR1 or an output XA4 of the HSR4 is selected based on the polarity of CSH and its inverted signal XCSH. In the following description, it is assumed that H is transferred in a direction from the HST1 toward the HSR4 and that XA1 is selected.

Four inverters INV (in FIG. 14, one “inverter” is shown as a set of three inverters which are serially connected) and four NAND gates NAND (in FIG. 14, one “NAND gate” is shown as a set of a NAND gate and two inverters which are serially connected) are provided corresponding to HSR1-HSR4. The XA1 from the HSR1 is input to four inverters INV. To four NAND gates NAND are input the XA1 from the HSR1 and a NOR signal of A2 and A3 from the HSR2 and HSR3 obtained by a NOR gate NOR.

Video data processor circuits 46 corresponding to R, G, and B are connected to the pair of the inverter INV and the NAND gate NAND. That is, video data processor circuits 46 for R, for G, and for B are connected to each of HSR1-HSR4.

As described before, R, G, and B (3 colors) * 4=12 lines are provided in parallel as the VopeSignal and VideoIsignal, and corresponding one VopeSignal and corresponding one VideoIsignal are input to each of 12 video data processor circuits 46.

Therefore, with this circuit, operation point voltage signals VopeSignal and current video signals VideoISignal are simultaneously written to 12 video data processor circuits 46.

FIG. 15 shows a timing chart. On a rise of a clock CKH1 after a horizontal start signal STH becomes H, an output of the shift register DSR1 becomes an H level, and transfer of the H level through the HSR1-HSR4 is started. Specifically, an output of the HSR1 becomes an H level at the first fall of the clock CKH1 after D1 rises and becomes an L level at the second fall of the clock CKH1. An output of the HSR2 becomes an H level at a first rise of the clock CKH1 after D1 rises and becomes an L level at the second rise of the clock CKH1. An output of the HSR3 becomes an H level at a second fall of the clock CKH1 and becomes an L level at a third fall of the clock CKH1. An output of the HSR4 becomes an H level at a second rise of the clock CKH1 and becomes an L level at a third rise. Therefore, in a second half of the H period of the output of the HSR1, the output of the HSR2 is also H, in a second half of the H period of the output of the HSR2, the output of the HSR3 is also H, and in a second half of the H period of the output of the HSR3, the output of the HSR4 is also H.

The L level of the XA1 is supplied to each video data processor circuit 46 through the inverter INV as the VSR_V. In this manner, the operation point voltage signal VopeSignal is supplied to 12 video data processor circuits 46 during when the output of the HSR1 is at H.

To the NAND gate, XA1 and an output from the NOR gate NOR are supplied. The output signals A2 and A3 from the HSR2 and HSR3 are supplied to the NOR gate NOR. Therefore, the output XISWE from the NOR gate NOR is L when at least one of signals A2 and A3 is H. The output of the NAND gate NAND becomes H when at least one of signals XA1 and XISWE is L. Therefore, when any of the outputs of the HSR1, HSR2, and HSR3 are H, the output from the NAND gate NAND becomes H and is supplied to 12 video data processor circuits 46 as VSR_I.

In this manner, in the 12 video data processor circuits 46, writing of the operation point voltage signal and the current video signal are simultaneously performed.

When processes by the 12 video data processor circuits 46 as described are completed, the operation point voltage signal VopeSignal and the current video signal VideoISignal are switched to the values for the next set of pixels, and data is simultaneously written in the next set of 12 video data processor circuits 46 through an operation similar to the above while transferring H through four horizontal shift registers HSR5-HSR8.

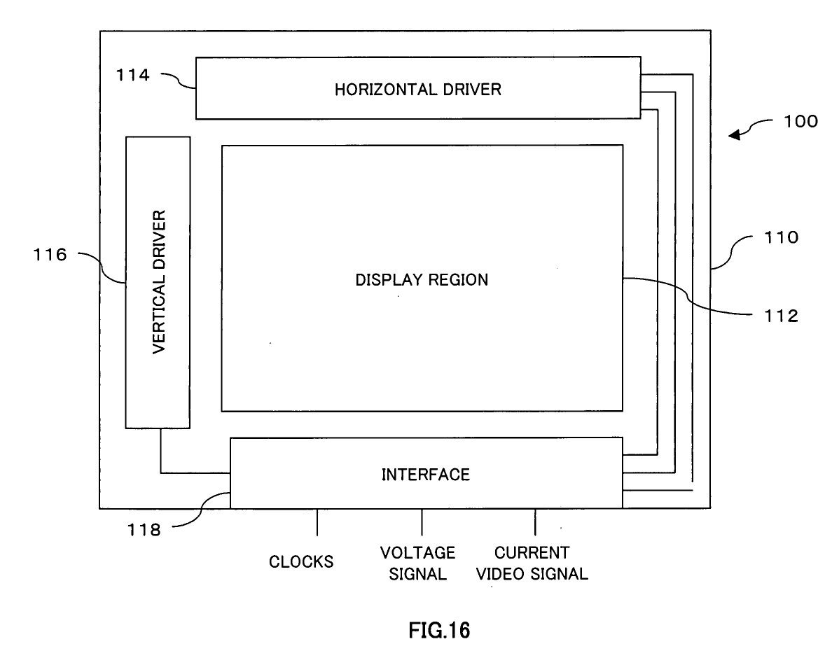

FIG. 16 is a diagram schematically showing an overall structure of a display device 100 according to a preferred embodiment, and shows a general structure of a pixel substrate. A pixel substrate 110 is formed of, for example, a glass substrate, and a central portion of the substrate in FIG. 16 is a display region 112 in which a plurality of pixels are placed. A horizontal driver 114 is provided above the display region in FIG. 16. The horizontal driver 114 includes a horizontal shift register 40, a video data processor circuit 46, etc., and supplies a voltage signal and a current video signal onto a data line DL. On the left side of the display region as shown in FIG. 16, a vertical driver 116 is provided. The vertical driver 116 controls Write line and Erase line which extend along the horizontal direction and determines a horizontal line to be selected.

Below the display region 112 of the pixel substrate in FIG. 16, an interface 118 is provided to which various clocks, voltage signal, current video signal, etc., are supplied from outside of the device. The interface 118 supplies a predetermined clock necessary for transfer in the horizontal direction, the voltage signal, and the current video signal to the horizontal driver 114, and supplies a clock necessary for transfer in the vertical direction to the vertical driver 116. Therefore, in the display region 112, display is created based on the externally-supplied current video signal.

A typical video signal has a voltage indicative of a brightness value, and a current video signal is generated by converting the video signal from the voltage to current. Although the present embodiment is configured to receive an externally-supplied voltage signal and a current video signal, it is also possible to configure the present invention such that a typical video signal is received and that a voltage signal and a current video signal are generated within the display device.

What is claimed is:

1. A display device having an emissive element in each of pixels arranged in a matrix form and in which a display is achieved, the display device comprising:
a video data processor circuit for receiving both a voltage signal and a current video signal for a pixel, storing a voltage when a current corresponding to the current video signal is supplied, and outputting a data current corresponding to the stored voltage;
a data line to which a data current is supplied from the video data processor circuit; and
a pixel circuit connected to the data line for storing a voltage corresponding to a data current flowing on the data line and for driving a driver element based on the stored voltage to allow the emissive element to emit light.

2. A display device according to claim 1, wherein
the video data processor circuit sets a voltage using both the voltage signal and the current video signal at an early stage and then receives only the current video signal, and stores a voltage corresponding to the current video signal.

3. A display device according to claim 2, wherein
the video data processor circuit comprises at least two pairs of storage units for separately storing a voltage corresponding to a current video signal for one line, and output units for supplying a data current corresponding to the voltage for one line stored in the storage units to the corresponding data line, wherein
when the voltage signal or the current video signal is written into the storage unit of one of the sets, the data current is output from the output unit of the other set onto the data line, and these operations are sequentially switched to achieve a line sequential display.

4. A display device according to claim 1, wherein
the video data processor circuit comprises an output transistor in which a voltage signal and a current video signal are supplied to a gate and a drain while the gate and the drain are short-circuited and a storage unit for storing a gate voltage of the output transistor; and
the output transistor outputs a data current to the data line based on a voltage stored in the storage unit.

5. A display device according to claim 4, wherein
the driver element in the pixel circuit is a transistor, and
the driver element and the output transistor of the video data processor circuit are of opposite conductive types.

6. A display device according to claim 1, wherein
the current video signals and the voltage signals for a plurality of adjacent pixels within one horizontal line are simultaneously supplied to the video data processor circuit in parallel.

7. A display device according to claim 1, further comprising:
a current-to-voltage converter circuit for outputting, based on a data current output from the video data processor circuit, a voltage signal for corresponding data line, wherein
the current-to-voltage converter circuit supplies the voltage signal for data line and the data current to the data line.

8. A display device according to claim 1, further comprising:
a horizontal shift register including a register corresponding to each column of the pixels arranged in matrix form, wherein
a selection signal for allowing sequential supply of the voltage signal and the current signal to the data line of each column is output from the horizontal shift register.

9. A display device according to claim 8, wherein
in the video data processor circuit , reception of the voltage signal and of the current video signal is controlled by an output from the horizontal shift register.

10. A display device according to claim 1, wherein
the video data processor circuit comprises three transistors and a capacitor.

11. A display device according to claim 3, wherein
in the two sets of output units, one terminal is connected to the data line and the other terminal is connected to separate and divided power supply lines which are connected to a power supply.

12. A display device according to claim 3, wherein
a selection transistor is provided corresponding to each storage unit for controlling which of the two sets of storage units the current video signal is to be supplied to allow the storage unit to store a voltage corresponding to the current video signal; and
control lines are separately provided corresponding to the two selection transistors, for supplying, to the two selection transistors, control signals for controlling which of the two selection transistor is to be switched on.

13. A display device according to claim 12, wherein
the control signals are a pair of complementary signals which become high level and low level every one horizontal line.

14. A display device according to claim 13, wherein
the control signal is output only during a vertical display period other than a vertical return period.

15. A display device according to claim 14, wherein
the control signals are generated through a logical operation of a pair of complementary signals CKV1 and CKV2 which become a high level and a low level every one horizontal line, a signal STV which is a signal indicating a start timing of a vertical display period, and a signal VOUT which is a signal indicating a completion timing of the vertical display period.

16. A display device according to claim 1, wherein
the video data processor circuit comprises:
a capacitor for storing a voltage corresponding to a current video signal;
an input control transistor for controlling a supply of the current video signal into the capacitor;
an output transistor for receiving a voltage stored in the capacitor in a control terminal and for outputting a corresponding data current; and
an output control transistor for controlling whether or not to output the output of the output transistor onto the data line; wherein
the input control transistor and the output control transistor are controlled by control signals supplied from separately provided control lines.

17. A display device according to claim 1, wherein
two data lines are provided for each column;
pixel circuits of one column are alternatively connected to the two data lines;
a voltage signal or a current video signal is supplied for two horizontal periods from one of the data lines to one pixel circuit;
a voltage signal or a current video signal is supplied for two horizontal periods from the other data line to the pixel circuit on one column below at a timing which is delayed by one horizontal period; and
these operations are sequentially repeated for successive pixel circuits.

18. A display device according to claim 17, wherein
the voltage signal is supplied onto the data line for the first one horizontal period of the two horizontal periods; and
the current video signal is supplied onto the data line for the second one horizontal period of the two horizontal periods.

19. A display device having an emissive element in each of pixels arranged in a matrix form, which creates a display by causing the emissive element to emit light, wherein
the display device receives, from outside of the device, two types of video signals of a voltage signal determined based on an emission brightness of the emissive element and of a current signal determined based on an emission brightness of the emissive element, and
the emission brightness of the emissive element is controlled using the two types of video signals.
